(19) United States
(12) Patent Application Publication
(10) Pub. No.: US 2026/0225879 A1
(43) Pub. Date: Aug. 6, 2026

(54) MULTI-STAGE MEMBRANE REACTOR SYSTEM FOR AMMONIA CRACKING TO PRODUCE HYDROGEN

(71) Applicant: Saudi Arabian Oil Company, Dhahran (SA)

(72) Inventors: Nicholas J. Pengilly, Dhahran (SA); Mohammad Abdur Rakib, Dhahran (SA); Rakesh Kumar, Al Khobar (SA)

(21) Appl. No.: 19/043,752

(22) Filed: Feb. 3, 2025

(51) Int. Cl. C01B 3/04

(52) U.S. Cl. CPC C01B 3/047; C01B 2203/041; C01B 2203/1058; C01B 2203/1064; C01B 2203/1205

(57) ABSTRACT

A method of multi-stage ammonia cracking to produce hydrogen (H₂), the method including providing a pressurized ammonia (NH₃) to a first reactor including a first hydrogen-selective membrane tube at a first pressure. The method further includes catalytically cracking the NH₃ within the first reactor to form H₂ and nitrogen (N₂). A first permeate from the first membrane tube includes the H₂, and a first retentate from the first membrane tube includes unreacted NH₃. The method further includes recovering the first permeate as a pressurized H₂ product stream. The method further includes providing the first retentate to a second reactor including a second hydrogen-selective membrane tube at a second pressure that is lower than the first pressure. The method further includes catalytically cracking the unreacted NH₃ within the second reactor to form additional H₂ and N₂. The method further includes recovering a second permeate as an additional H₂ product stream.

### TECHNICAL FIELD

This disclosure relates to multi-stage membrane reactor system for ammonia cracking to produce hydrogen and the method of hydrogen production using the same.

### BACKGROUND

Hydrogen (H₂) is a promising energy carrier due to its potential to significantly reduce greenhouse gas emissions. It can be produced through various methods, including electrolysis of water, steam methane reforming (SMR), and biomass gasification. The produced H₂ can be a feedstock to chemical processes, such as fuel cells, ammonia (NH₃) production, aromatization, hydrodesulphurization, and the hydrogenation or hydrocracking of hydrocarbons. The hydrogen can also be used as a fuel for decarbonization of industrial assets, for power generation through fuel cell or through combustion in a gas turbine or combustor. However, long-haul transportation of H₂ can be impractical due to its low energy density and the difficulty in storage. One approach to overcome these issues is to chemically convert H₂ into NH₃ as an energy storage medium. NH₃ can be shipped in condensed liquefied form, which significantly improves the transportation efficiency thanks to higher energy per weight. Chemical retrieval of H₂ can be achieved at the end user facility by ammonia cracking. This reaction is a highly endothermic process, favored at higher temperatures and lower pressures. Such endothermic gaseous reactions can generally be conducted in catalyst-filled tubes housed inside a furnace, similar to the SMR process. In these reactor systems, reactor designs may play a critical role in efficient product removal, balanced heat management, and catalyst performance.

### SUMMARY

This disclosure describes technologies relating to multi-stage membrane reactor system for ammonia cracking to produce H₂. The unique multi-stage membrane reactor design uses a series of membrane reactors, enabling the efficient production of high pressure H₂, e.g., 2-3 MPa, and in-situ gas separation. Each membrane reactor, operatable at different pressures, can use one or more hydrogen-selective membrane tubes to separate produced H₂ as a permeate. Compared with a single stage membrane reactor system, this multi-stage membrane design improves the energy efficiency of process of ammonia cracking by, for example, eliminating the need for product gas compression. Further, the continuous H₂ removal form the reaction zone can enhance the ammonia conversion beyond local equilibrium. The technology described herein can therefore help achieving better hydrogen yield and lower process and equipment cost compared to existing technologies.

### BRIEF DESCRIPTION OF DRAWINGS

FIG. 1 is a schematic illustration of a multi-stage membrane reactor system having two membrane reactors in hydrogen-out (H₂-in) configuration.

FIG. 2 is a schematic illustration of a multi-stage membrane reactor system having two membrane reactors in hydrogen-out (H₂-out) configuration.

FIG. 3 is a schematic illustration of a multi-stage membrane reactor system for adiabatic mode.

FIG. 4 is a schematic illustration of a multi-stage membrane reactor system for isothermal mode.

FIG. 5 is a schematic illustration of a multi-stage ammonia cracking process diagram.

FIG. 6 is an example process flow diagram of methods of ammonia cracking using a multi-stage membrane reactor system.

### DETAILED DESCRIPTION

Implementations described herein provide multi-stage membrane reactor systems for ammonia cracking to produce H₂ and the method of H₂ production using the same. Generally, NH₃ is considered as an attractive energy storage medium and ammonia cracking to retrieve H₂ is an emerging technology that promotes the H₂-based economy. Conventional methods of ammonia cracking are often faces with challenges of low pressure H₂ as product, which may require a subsequent costly step of pressuring the H₂ for various applications. The multi-stage membrane reactor system of this disclosure addresses this issue through enabling high pressure conversion of NH₃ and in-situ H₂ separation. The energy required to compress NH₃ is significantly less that the energy required to compress and purify H₂. Accordingly, in various implementations, the method includes compressing NH₃ such that the initial stage of the ammonia cracking is performed at a high pressure, e.g., above 3 MPa. This can result in a high pressure H₂ product stream and eliminates the step of product compression. By applying a series of membrane reactors, any unreacted NH₃ can be further processed in one or more subsequent membrane reactors downstream to the first reactor for producing additional H₂. The pressure can be accordingly adjusted at each stage of the process to optimize the yield of high pressure H₂ and overall process efficiency.

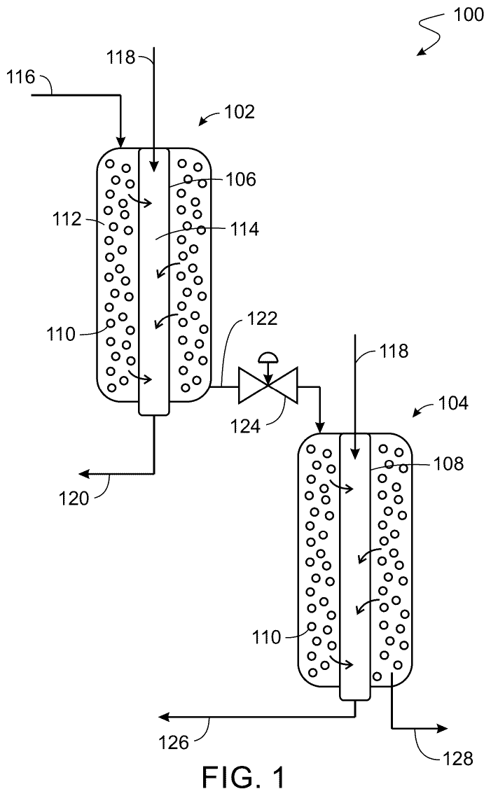

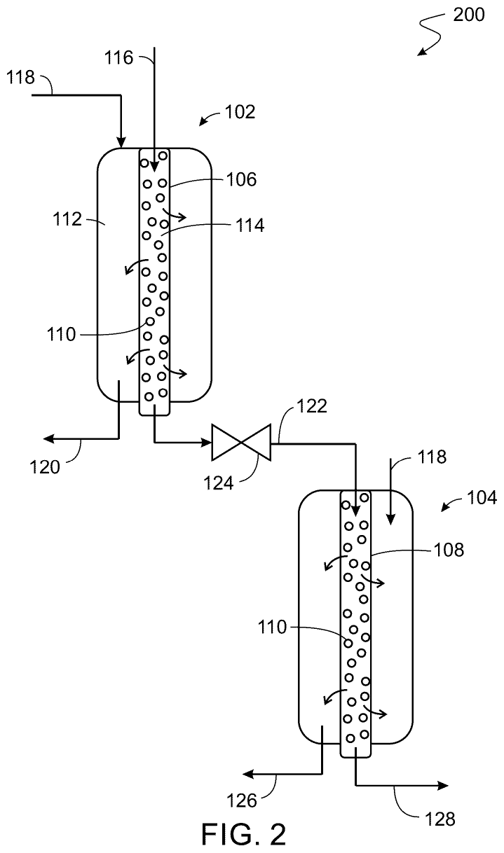

In various implementations, the multi-stage membrane reactor system of this disclosure can be operated in one of two main configurations depending on the location of the catalyst in the membrane reactor. In the first (“H₂-in”) configuration as further described referring to FIG. 1, the catalyst is loaded outside the hydrogen-selective membrane tube, and a portion of the produced H₂ permeates inward through the tube walls. On the other hand, in the second (“H₂-out”) configuration as further described referring to FIGS. 2-4, the catalyst for ammonia cracking is loaded inside the hydrogen-selective membrane tube and a portion of the produced H₂ permeates outward through the tube walls. The configuration can be selected in view of the reactor size, process conditions, heat management, and other factors. While each figure of this disclosure is illustrated for one of the configurations for illustration purpose, other configurations are also possible. For example, in FIGS. 1-2, two membrane reactors are illustrated to be in the same configuration, but the configuration for each membrane reactor can be selected individually.

In FIG. 1, a multi-stage membrane reactor system 100 includes two reactors: a first membrane reactor 102 and a second membrane reactor 104. As illustrated, each reactor includes a hydrogen-selective membrane tube: a first hydrogen-selective membrane tube 106 and a second hydrogen-selective membrane tube 108. In various implementations, a hydrogen-selective membrane tube and the location of a catalyst 110 (indicated by dots in FIGS. 1-2) to facilitate the ammonia cracking reaction defines a permeate side and a retentate side. Here, the retentate side of a hydrogen-selective membrane tube is defined as the side in which the NH₃ is cracked. In FIG. 1, the catalyst is loaded outside 112 of the tube, illustrating a H₂-in configuration. In this case, the outside 112 of the tube is the retentate side and the inside 114 is the permeate side.

In FIG. 1, the schematic of the multi-stage membrane reactor system 100 is simplified for illustration purpose, including its size and dimensions, relative positions of each reactor components, and the number of each component. For example, the multi-stage membrane reactor system 100 of FIG. 1 is drawn to have one tube for each membrane reactor for illustration purposes, but in various implementations, any number of these membrane tubes can be used for each stage. For example, multiple tubes can be bundled in parallel and form a membrane reactor. The dimensions and numbers of the membrane tubes can be determined according to factors such as target throughput and the size and volume of the reactor system. In various implementations, the membrane reactor, e.g., the first membrane reactor 102 and the second membrane reactor, is a cylindrical containment suitable for accommodating high internal pressure, e.g., >5 MPa, but any other shape and design can be used in other implementations. Further in FIG. 1, the entire length of each membrane tube is enclosed inside the membrane reactor, but in some implementations, one or more membrane tubes can be extended out of the membrane reactor at one or both ends.

The use of a series of membrane reactors can enable and benefit from separate process flows, e.g., permeate and retentate, at each stage. Accordingly, in various implementations, each of the membrane tube, e.g., the first hydrogen-selective membrane tube 106 and the second hydrogen-selective membrane tube 108, can include at least a set of two gas inlets and two gas outlets.

As illustrated in FIG. 1, in the H₂-in configuration, a reactant gas 116 including NH₃ is flowed to the outside 112 of the tube. In various implementations, a sweep gas 118 can be separately flowed to the inside 114 of the tube to facilitate H₂ permeation through the tube walls. A product gas stream 120 containing high pressure H₂, .e.g., above 1 MPa, above 2 MPa, or above 3 MPa, can be obtained as a permeate from the inside 114 of the tube. A retentate stream 122 containing some unreacted NH₃ can be fed to the second membrane reactor 104, e.g., the outside of the tube as illustrated in FIG. 1 (H₂-in configuration) for further cracking of the NH₃.

In some implementations, the multi-stage membrane reactor system 100 includes a pressure control system that adjust the pressure for each membrane reactor. The pressure control system can include various components necessary for this purpose, e.g., a pressure valve 124 as illustrated in FIG. 1.

The unreacted NH₃ in the retentate stream 122 can be cracked over the catalyst 110 in the second membrane reactor 104 to produce additional H₂ and N₂. An additional product stream 126 containing the additional H₂ can be recovered at a pressure lower than the product gas stream 120. An additional retentate stream 128 can be recovered and processed for gas separation and/or further cracking if any NH₃ remains unreacted.

In the H₂-out configuration (FIGS. 2-4), the reactant flow 116 and the sweep gas 118 are switched to each other. In FIG. 2, a multi-stage membrane reactor system 200 is illustrated to describe such implementations. The reactor components can be similar or identical to those in FIG. 1, except the location of the catalyst and process flow configurations, and thus will not be repeated. In FIG. 2, the catalyst 100 is loaded inside 114 of the tube, and the reactant gas 116 including NH₃ is flowed to the inside 114 of the tube. In implementations where the sweep gas 118 is used, it is flowed to the outside 112 of the tube, which becomes the permeate side. The product gas stream 120 containing high pressure H₂ can be recovered from the permeate side (the outside 112). The retentate stream 122 can be recovered and fed to the second membrane reactor 104, e.g., the inside of the tube where the catalyst 110 is loaded, to produce the additional product stream 126 containing the additional H₂, which can be recovered from the outside of the tube. The additional retentate stream 128 can be recovered from the inside of the tube.

The hydrogen-selective membrane tube separates at least a portion of the produced H₂ from the ammonia cracking reaction as a purified product stream. Generally, high conversions of NH₃, e.g., >99%, can be obtained by continuous removal of H₂ from the reaction environment to continuously shifting the equilibrium towards complete conversion. The use of selective membrane enables this product separation. Referring back to FIG. 1, the hydrogen-selective membrane tube, e.g., the first hydrogen-selective membrane tube 106 allow only H₂ to permeate through its walls into the permeate side (the inside 114 of the tube in FIG. 1), while blocking and retaining all other species in the retentate side (the outside 112 of the tube in FIG. 1).

The level of hydrogen separation depends on the membrane permeance factor as well as the partial pressure differential between the two sides. While it may be desirable to have all the generated H₂ permeated, it may not be practically achievable and the permeation stops as soon as the H₂ partial pressures on the two sides become equal. In addition, the pressure differential increases only incrementally as the partial pressures reach towards equalization on both sides. Hence, long membrane lengths may become unviable.

In various implementations, the hydrogen-selective membrane tube can be characterized or labeled as cylindrical membranes or hollow membranes. The material of this membrane can be, for example, a palladium (Pd) or Pd alloy. The membrane can be a thin film of Pd alloy supported on a tubular porous substrate composed of a metal or metal oxide. Other materials suitable for the hydrogen-selective membrane tube can include ceramic materials such as perovskite oxides. The membrane material can be selected to have a sufficient thermal stability at a reaction temperature, e.g., >550° C., and H₂ permeability and selectivity at this temperature. For example, a Pd alloy such as palladium-silver (Pd—Ag), palladium-gold (Pd—Au), and palladium-copper (Pd—Cu) can be used for high hydrogen flux and high purity, e.g., >99.99%.

In various implementations, the sweep gas 118 enhances the H₂ permeation through the tube walls. Since it is practically difficult to attain zero H₂ partial pressure in the permeate side, not all H₂ produced in the process can be collected from the permeate side. Having the flow of the sweep gas 118 in the permeate side can reduce the H₂ partial pressure in the hydrogen-selective membrane tube, and thus enhance the separation.

In various implementations, the sweep gas 118 can be co-current or countercurrent with respect to the flow direction of the reactant gas 116. In FIGS. 1-2, the sweep gas 118 in co-current for illustration purpose only. The merits of the two configurations, co-current and countercurrent, depend on the scale and the pressure in the retentate side.

In various implementations, the sweep gas 118 includes steam. The use of steam for the sweep gas 118 offer the advantage of a cost-effective, inert carrier gas to dilute the H₂ on the permeate side of the hydrogen-selective membrane tube 104. It can reduce the partial pressure of H₂ on the permeate side and thereby enhance the driving force for permeation. The steam can be readily condensed and separated from the product gas stream by a subsequent separation unit, which can be more economical and energy efficient compared to implementations with other sweep gases such as helium (He) or N₂. In some implementations, the sweep gas 118 includes NH₃.

In various implementations, the catalyst 110 is a metal catalyst based on noble metals or transition metals. Example metals for the catalyst 110 include nickel (Ni), cobalt (Co), iron (Fe), Ruthenium (Ru), platinum (Pt), palladium (Pd), vanadium (V), molybdenum (Mo), and lanthanum (La).

In various implementations, the reaction temperature for ammonia cracking depends on the type of catalyst. For example, using Ni-based catalysts, the process may require the temperature range of 800 to 900° C. Co-based catalysts, however, can operate in the rage of 550 to 650° C. This temperature can be lowered while maintaining the level of conversion by using a membrane reactor that enables continuous product removal. Accordingly, in various implementations, the multi-stage membrane reactor system of this disclosure can achieve high conversions at lower temperatures of about from 500° C. to 600° C. even for the Ni-based catalysts. The operation at lower temperatures can be advantageous for the materials standpoint as well because the Pd membrane used for the hydrogen-selective membrane tube can be stable up to about 600° C. The temperature will remain the same for each stage.

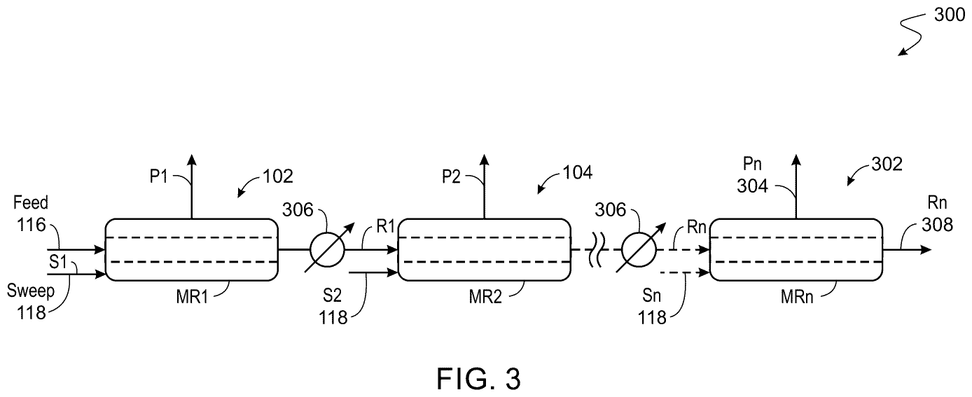

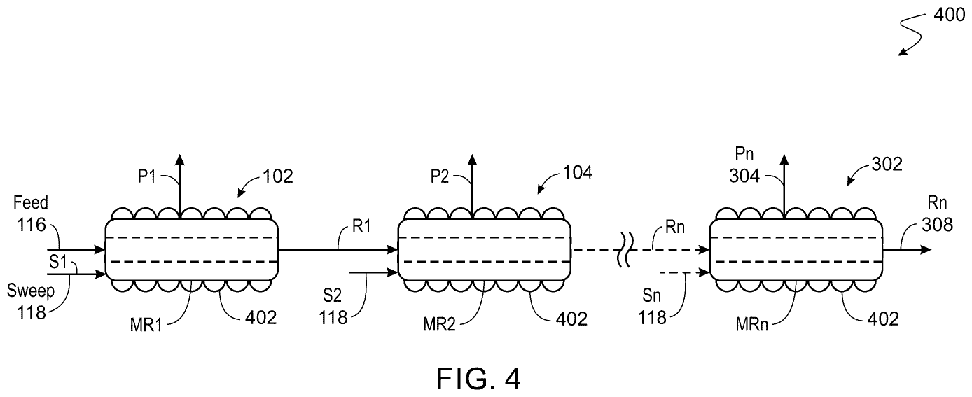

While FIGS. 1-2 illustrate implementations where the multi-stage membrane reactor system has two stages, the numbers of stages and membrane reactors are not limited. The multi-stage membrane reactor system can be designed to have more than two, e.g., three, four, or more, stages and membrane reactors for optimal H₂ yield, particularly high pressure H₂, and the NH₃ conversion. Such implementations are illustrated in FIGS. 3-4.

In FIG. 3, a multi-stage membrane reactor system 300 has n number of membrane reactors. For illustration purpose, only a first membrane reactor 102, a second membrane reactor, and a n^{th} membrane reactor 302 are illustrated. Since various components of the reactor system can be similar or identical to those described previously referring to FIGS. 1-2, e.g., catalyst, they will not be repeated. In FIG. 3, the multi-stage membrane reactor system 300 is illustrated to have the H₂-out configuration as described previously referring to FIG. 2. Accordingly, in FIG. 3, a reactant gas 116 including NH₃ is flowed to the inside of the tube, while a sweep gas 118 is separately flowed to the outside of the tube. The H₂-in configuration is also possible. In some implementations, the configuration can be selected individually for each stage. At each stage, a product gas stream can be recovered from the corresponding membrane reactor. In this case, the number of product gas stream can therefore be n, where a final product gas stream 304 is recovered from the n^{th} membrane reactor 302.

In various implementations, as illustrated in FIG. 3, the multi-stage membrane reactor system 300 can be designed for and operated in adiabatic mode. Accordingly, the membrane reactors of the multi-stage membrane reactor system 300 can be thermodynamically insulated to eliminate or minimize heat exchange with environment or external heat source. Further, a pressure control system 306, e.g., pressure regulator, can be inserted between the membrane reactors such that each stage can be performed at different internal pressures. In some implementations, additional reactor components necessary, e.g., for pressure and temperature control, can be present in the multi-stage membrane reactor system 300. Further, some of the components can be omitted. In various implementations, the sweep gas 118 is individually flowed for each membrane reactor as illustrated in FIG. 3. The pressure and flow rate of the sweep gas 188 can also be individually controlled to optimize the H₂ permeation at each stage. In various implementations, a final retentate stream 308 is primarily N₂ produced from the cracking reaction. In some implementations, the final retentate stream 308 is substantially NH₃-free after complete conversion. In other implementations, the final retentate stream 308 contains some residual unreacted NH₃. If present, the remaining NH₃ can be separated by a gas separation process and recycled back to the multi-stage membrane reactor system 300.

In FIG. 4, a multi-stage membrane reactor system 400 is modified from that in FIG. 3 to enable isothermal processes. Accordingly, each membrane reactor of the multi-stage membrane reactor system 400 is equipped with a heater 402 surrounding the reactor to heat the reactants. Similar to FIG. 3, for illustration purpose, only a first membrane reactor 102, a second membrane reactor, and a n^{th} membrane reactor 302 are illustrated. Various components, e.g., a pressure control system, can be present or omitted from the multi-stage membrane reactor system 400.

In some implementations, a portion of the produced H₂ can be used to generate heat, e.g., combustion, and use the generated heat for heating one or more of the membrane reactors. Such implementations can mitigate the use of external energy and help making the ammonia cracking process self-sustaining.

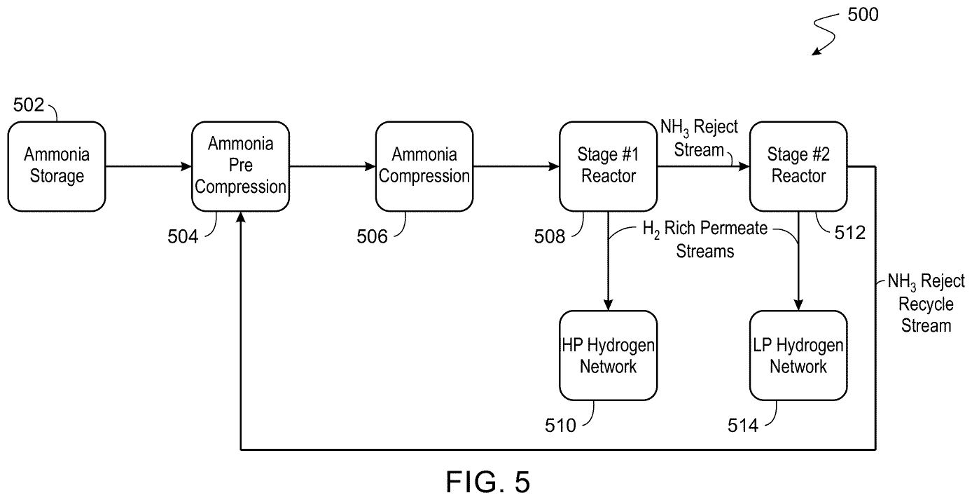

FIG. 5 is a schematic illustration of a cracking process diagram 500, which can be performed using the multi-stage membrane reactor system of this disclosure. A two-stage cracking process is described as example. As illustrated in FIG. 5, in various implementations, the feed stream can be obtained from a liquid ammonia storage system or tanks 502. At a step 504, the NH₃ can then be pressurized to an intermediate pressure, e.g., above 1 MPa, above 2 MPa, above 3 MPa, from about 1 MPa to about 4 MPa, from about 2 MPa to about 4 MPa, from about 3 MPa to about 4 MPa, from about 1 MPa to about 3 MPa, from about 1 MPa to about 2 MPa, or about 3.3 MPa.

Subsequently, at a step 506, the NH₃ is further pressurized to the initial process pressure for the initial stage of ammonia cracking. For example, the initial process pressure is above 3 MPa, above 4 MPa, above 5 MPa, from about 3 MPa to about 6 MPa, from about 4 MPa to about 6 MPa, from about 5 MPa to about 6 MPa, from about 3 MPa to about 5 MPa, from about 3 MPa to about 4 MPa, or about 5 MPa. The initial process pressure can be selected to balance the benefit of enhanced permeation and the adverse effects on equilibrium and possible liquefaction of the reactant.

This pressurized NH₃ can then be processed by a first stage 508 using a first membrane reactor at the initial process pressure. The ammonia molecules are cracked over the catalyst to form H₂ and N₂. At least a portion of the produced H₂ can permeate through the H₂-selective membrane and be recovered as a high pressure H₂ stream. The high pressure H₂ stream can have a pressure above 1 MPa, above 2 MPa, above 3 MPa, above 4 MPa, from about 2 MPa to about 4 MPa, from about 3 MPa to about 4 MPa, from about 1 MPa to about 3 MPa, from about 1 MPa to about 2 MPa, about 3 MPa, or about 4 MPa. The high pressure H₂ stream can be sent to a hydrogen network 510 for various applications. For example, it can be used as a feedstock where high pressure H₂ is desired. In some implementations, the hydrogen network 510 can include hydrogen applications for chemical conversions, e.g., methanol synthesis and hydrocracking.

The retentate stream that is rejected by the H₂-selective membrane in the first membrane reactor can still contain unreacted NH₃, which can be processed further by a second stage 512 using a second membrane reactor for additional H₂ production. In some implementations, the pressure of the retentate stream is adjusted for the second stage. In various implementations, the second stage pressure is lower than the initial process pressure. For example, the second stage pressure can be above 1 MPa, above 2 MPa, above 3 MPa, from about 1 MPa to about 4 MPa, from about 2 MPa to about 4 MPa, from about 3 MPa to about 4 MPa, from about 1 MPa to about 3 MPa, from about 1 MPa to about 2 MPa, or about 3.5 MPa.

At least a portion of the additionally produced H₂ can permeate through the H₂-selective membrane in the second membrane reactor and be recovered as a low pressure H₂ stream. The low pressure H₂ stream can have a pressure above 0.1 MPa, above 0.3 MPa, above 0.5 MPa, from about 0.3 MPa to about 0.5 MPa, from about 0.1 MPa to about 0.3 MPa, or about 0.5 MPa. The low pressure H₂ stream can be sent to a hydrogen network 512 for various applications. For example, it can be used as a feedstock where low pressure H₂ is desired. In some implementations, the hydrogen network 512 can be different from the hydrogen network 510. In some implementations, the hydrogen network 512 can include hydrogen applications for hydrogenation, fuel cells, and other power generations.

In some implementations, as illustrated in FIG. 5, the retentate stream after the second stage 512 is recycled back to the step 504 of pre-compression. Although not specifically illustrated, NH₃ separation can be performed prior to recycling back the stream to the step 504. Further, in other implementations, the retentate stream after the second stage 512 is further processed by one or more subsequent membrane reactors (not illustrated). Accordingly, the multi-stage ammonia cracking process generates multiple H₂ product streams at different pressures depending on the process pressure at each stage. The recovered H₂ streams can be individually sent to various applications depending on its pressure and quality. In various implementations, the reactant gas undergoes sequential pressure reductions in a cascade fashion through multiple stages, where each stage is designed to lower the process pressure while optimizing the overall system efficiency.

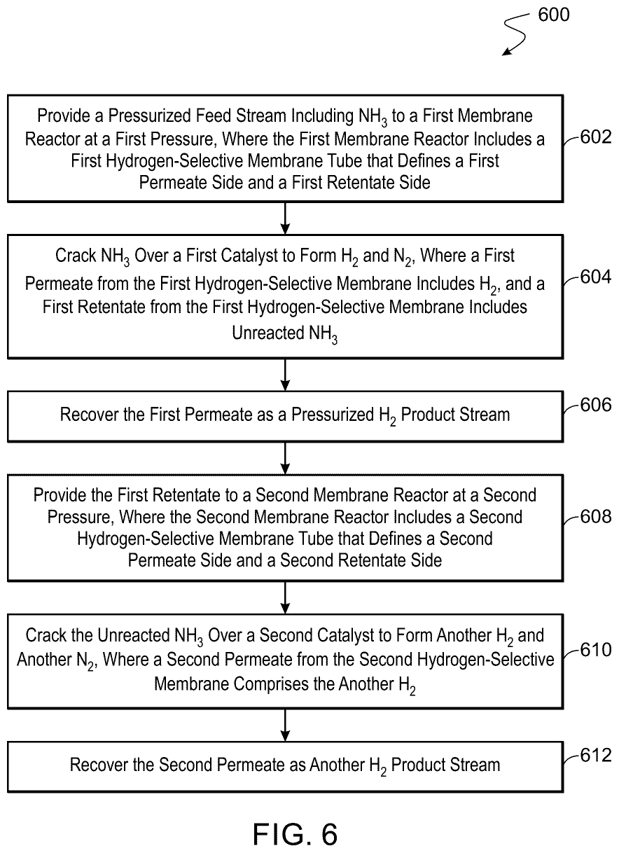

FIG. 6 is an example process flow diagram of methods of ammonia cracking to produce hydrogen using a multi-stage membrane reactor system. A process 600 starts with a step 602 of providing a pressurized feed stream including NH₃ to a first membrane reactor at a first pressure. The first membrane reactor can have a first hydrogen-selective membrane tube that defines a first permeate side and a first retentate side. Here, a retentate side of a hydrogen-selective membrane tube is defined as a side in which the NH₃ is cracked. At a step 604, the NH₃ is cracked over a first catalyst within the first membrane reactor to form H₂ and N₂. A first permeate from the first hydrogen-selective membrane includes the H₂, and a first retentate from the first hydrogen-selective membrane includes unreacted NH₃. At a step 606, the first permeate is recovered as a pressurized H₂ product stream. In some implementations, the pressurized H₂ product stream having a pressure above 1 MPa, e.g., about 3 MPa. At a step 608, the first retentate is subsequently provided to a second membrane reactor at a second pressure. The second pressure can be lower than the first pressure. The second membrane reactor can have a second hydrogen-selective membrane tube that defines a second permeate side and a second retentate side. At a step 610, the unreacted NH₃ is cracked over a second catalyst within the second membrane reactor to form additional H₂ and N₂. A second permeate from the second hydrogen-selective membrane includes the additional H₂. At step 612, the second permeate is recovered as an additional H₂ product stream.

### Implementations

An implementation described in this disclosure provides a method of multi-stage ammonia cracking to produce hydrogen. The method includes providing a pressurized feed stream including ammonia (NH₃) to a first membrane reactor at a first pressure. The first membrane reactor includes a first hydrogen-selective membrane tube that defines a first permeate side and a first retentate side. The method further includes cracking the NH₃ over a first catalyst within the first membrane reactor to form hydrogen (H₂) and nitrogen (N₂). Here, a first permeate from the first hydrogen-selective membrane includes the H₂, and a first retentate from the first hydrogen-selective membrane includes unreacted NH₃. The method further includes recovering the first permeate as a pressurized H₂ product stream. The method further includes providing the first retentate to a second membrane reactor at a second pressure. The second membrane reactor includes a second hydrogen-selective membrane tube that defines a second permeate side and a second retentate side, where the second pressure is lower than the first pressure. The method further includes cracking the unreacted NH₃ over a second catalyst within the second membrane reactor to form additional H₂ and N₂. Here, a second permeate from the second hydrogen-selective membrane includes the additional H₂. The method further includes recovering the second permeate as an additional H₂ product stream.

In an aspect, the method further includes flowing a sweep gas on the first permeate side of the first hydrogen-selective membrane tube, the second permeate side of the second hydrogen-selective membrane tube, or both.

In an aspect, the sweep gas includes steam or NH₃.

In an aspect, the sweep gas includes steam, the method further including condensing the steam present in the pressurized H₂ product stream into liquid water to purifying the H₂.

In an aspect, the sweep gas flowed as a countercurrent relative to a flow direction of the pressurized feed stream or the first retentate.

In an aspect, combinable with any other aspect, a second retentate including another unreacted NH₃ is formed on the second retentate side of the second hydrogen-selective membrane tube.

In an aspect, the method further includes cracking the another unreacted NH₃ in a third membrane reactor at a third pressure that is lower than the second pressure.

In an aspect, combinable with any other aspect, the first pressure is above 3 MPa.

In an aspect, combinable with any other aspect, the second pressure is above 1 MPa.

In an aspect, combinable with any other aspect, the pressurized H₂ product stream has a pressure above 1 MPa.

An implementation described in this disclosure describes a method of multi-stage ammonia cracking to produce hydrogen. The method includes pressuring a feed stream including ammonia (NH₃) to a first pressure above 3 MPa. The method further includes using a plurality of membrane reactors, catalytically cracking the NH₃ to form hydrogen (H₂) and nitrogen (N₂). The catalytically cracking includes cracking a first portion of the NH₃ at the first pressure in a first membrane reactor, forming a first H₂ product stream having a pressure above 1 MPa, and a first retentate stream including unreacted NH₃. The catalytically cracking further includes recovering the first H₂ product stream as a permeate from the first membrane reactor. The catalytically cracking further includes providing the first retentate stream to a subsequent membrane reactor. The catalytically cracking further includes cracking at least a portion of the unreacted NH₃ in the subsequent membrane reactor at a pressure lower than the first pressure, forming a another H₂ product stream.

In an aspect, the method further includes flowing a sweep gas on a permeate side of at least one of the plurality of membrane reactors.

In an aspect, combinable with any other aspect, the catalytically cracking further includes providing a retentate stream from one of the plurality of membrane reactors to another of the plurality of membrane reactors as a feed for further cracking the NH₃.

In an aspect, combinable with any other aspect, the pressuring including pressuring the feed stream to an intermediate pressure between 2 MPa and 4 MPa and pressuring the feed stream from the intermediate pressure to the first pressure.

In an aspect, combinable with any other aspect, first pressure is 4-5 MPa, the second pressure is above 2.2-3.5 MPa, or the first H₂ product stream has a pressure 2-3 MPa.

An implementation described in this disclosure provides a multi-stage membrane reactor system. The system includes a first membrane reactor including a first hydrogen-selective membrane tube that defines a first permeate side and a first retentate side. The system further includes a second membrane reactor including a second hydrogen-selective membrane tube that defines a second permeate side and a second retentate side. The second membrane reactor is fluidically connected and downstream to the first retentate side of the first membrane reactor. The system further includes an ammonia cracking catalyst disposed within the first and second membrane reactors. The system further includes a pressure control system connected to the first and second membrane reactors and configured to adjust pressures of feed steams.

In an aspect, the system further includes a condenser to receive a mixture of hydrogen (H₂) and a sweep gas. The condenser is fluidically connected and downstream to the first membrane reactor.

In an aspect, combinable with any other aspect, the system further includes a heating system connected to the first membrane reactor, the second membrane reactor, or both, such that the multi-stage membrane reactor can be operated under an isothermal condition.

In an aspect, combinable with any other aspect, the first membrane reactor, the second membrane reactor, or both are thermodynamically insulated such that the multi-stage membrane reactor can be operated under an adiabatic condition.

In an aspect, combinable with any other aspect, the ammonia cracking catalyst includes cobalt (Co), nickel (Ni), or Ruthenium (Ru).

While this invention has been described with reference to illustrative implementations, this description is not intended to be construed in a limiting sense. Various modifications and combinations of the illustrative implementations, as well as other implementations of the invention, will be apparent to persons skilled in the art upon reference to the description. It is therefore intended that the appended claims encompass any such modifications or implementations.

What is claimed is:

1. A method of multi-stage ammonia cracking to produce hydrogen, the method comprising:
providing a pressurized feed stream comprising ammonia (NH₃) to a first membrane reactor at a first pressure, the first membrane reactor comprising a first hydrogen-selective membrane tube that defines a first permeate side and a first retentate side;
cracking the NH₃ over a first catalyst within the first membrane reactor to form hydrogen (H₂) and nitrogen (N₂), wherein a first permeate from the first hydrogen-selective membrane tube comprises the H₂, and a first retentate from the first hydrogen-selective membrane tube comprises unreacted NH₃;
recovering the first permeate as a pressurized H₂ product stream;
providing the first retentate to a second membrane reactor at a second pressure, the second membrane reactor comprising a second hydrogen-selective membrane tube that defines a second permeate side and a second retentate side, wherein the second pressure is lower than the first pressure;
cracking the unreacted NH₃ over a second catalyst within the second membrane reactor to form additional H₂ and N₂, wherein a second permeate from the second hydrogen-selective membrane tube comprises the additional H₂; and
recovering the second permeate as an additional H₂ product stream.

2. The method of claim 1, further comprising flowing a sweep gas on the first permeate side of the first hydrogen-selective membrane tube, the second permeate side of the second hydrogen-selective membrane tube, or both.

3. The method of claim 2, wherein the sweep gas comprises steam or NH₃.

4. The method of claim 2, wherein the sweep gas comprises steam, the method further comprising condensing the steam present in the pressurized H₂ product stream into liquid water to purifying the H₂.

5. The method of claim 2, wherein the sweep gas flowed as a countercurrent relative to a flow direction of the pressurized feed stream or the first retentate.

6. The method of claim 1, wherein a second retentate comprising another unreacted NH₃ is formed on the second retentate side of the second hydrogen-selective membrane tube.

7. The method of claim 6, further comprising cracking the another unreacted NH₃ in a third membrane reactor at a third pressure that is lower than the second pressure.

8. The method of claim 1, wherein the first pressure is above 3 MPa.

9. The method of claim 1, wherein the second pressure is above 1 MPa.

10. The method of claim 1, wherein the pressurized H₂ product stream has a pressure above 1 MPa.

11. A method of multi-stage ammonia cracking to produce hydrogen, the method comprising:
pressuring a feed stream comprising ammonia (NH₃) to a first pressure above 3 MPa;
using a plurality of membrane reactors, catalytically cracking the NH₃ to form hydrogen (H₂) and nitrogen (N₂), the catalytically cracking comprising,
cracking a first portion of the NH₃ at the first pressure in a first membrane reactor, forming a first H₂ product stream having a pressure above 1 MPa, and a first retentate stream comprising unreacted NH₃,
recovering the first H₂ product stream as a permeate from the first membrane reactor,
providing the first retentate stream to a subsequent membrane reactor, and
cracking at least a portion of the unreacted NH₃ in the subsequent membrane reactor at a pressure lower than the first pressure, forming a another H₂ product stream.

12. The method of claim 11, further comprising flowing a sweep gas on a permeate side of at least one of the plurality of membrane reactors.

13. The method of claim 11, wherein the catalytically cracking further comprises providing a retentate stream from one of the plurality of membrane reactors to another of the plurality of membrane reactors as a feed for further cracking the NH₃.

14. The method of claim 11, wherein the pressuring comprising:
pressuring the feed stream to an intermediate pressure between 2 MPa and 4 MPa; and
pressuring the feed stream from the intermediate pressure to the first pressure.

15. The method of claim 11, wherein the first pressure is 4-5 MPa, the second pressure is above 2.2-3.5 MPa, or the first H₂ product stream has a pressure 2-3 MPa.

16. A multi-stage membrane reactor system comprising:
a first membrane reactor comprising a first hydrogen-selective membrane tube that defines a first permeate side and a first retentate side;
a second membrane reactor comprising a second hydrogen-selective membrane tube that defines a second permeate side and a second retentate side, wherein the second membrane reactor is fluidically connected and downstream to the first retentate side of the first membrane reactor; and
an ammonia cracking catalyst disposed within the first and second membrane reactors;
a pressure control system connected to the first and second membrane reactors and configured to adjust pressures of feed steams.

17. The multi-stage membrane reactor system of claim 16, further comprising a condenser to receive a mixture of hydrogen (H₂) and a sweep gas, the condenser fluidically connected and downstream to the first membrane reactor.

18. The multi-stage membrane reactor system of claim 16, further comprising a heating system connected to the first membrane reactor, the second membrane reactor, or both, such that the multi-stage membrane reactor can be operated under an isothermal condition.

19. The multi-stage membrane reactor system of claim 16, wherein the first membrane reactor, the second membrane reactor, or both are thermodynamically insulated such that the multi-stage membrane reactor can be operated under an adiabatic condition.

20. The multi-stage membrane reactor system of claim 16, wherein the ammonia cracking catalyst comprises cobalt (Co), nickel (Ni), or Ruthenium (Ru).
